(19) United States
(12) Patent Application Publication
(10) Pub. No.: US 2025/0147821 A1
(43) Pub. Date: May 8, 2025

(54) SYSTEM AND METHOD FOR RESPONDING TO AN APPLICATION PROGRAMMING INTERFACE REQUEST

(71) Applicant: The Toronto-Dominion Bank, Toronto (CA)

(72) Inventors: Steven Robert LANGHAM, London (CA); Clara Gomez ELIZARRARAS, Toronto (CA); Hang Thu LY, London (CA); Andrew VAN, Toronto (CA); Smitaben SEN, Brampton (CA); Sugandha SUBRAMANIAN, Toronto (CA); Diyanshi Satishkumar CHAUDHARI, Brampton (CA); Riad ALI, Oakville (CA); Alekh SHARMA, Kitchener (CA); Mark Maher Guirguis Stephanos PHILIPS, Ottawa (CA); Christopher George DA COSTA, Toronto (CA); Yagnik Mukeshkumar PATEL, Toronto (CA); Geoffrey FRIGAULT, Ottawa (CA)

(73) Assignee: The Toronto-Dominion Bank, Toronto (CA)

(21) Appl. No.: 18/504,417

(22) Filed: Nov. 8, 2023

(51) Int. Cl. G06F 9/54; G06F 9/455

(52) U.S. Cl. CPC G06F 9/541; G06F 9/45533

(57) ABSTRACT

A computer system comprises at least one processor; a communications module coupled to the at least one processor; and a memory coupled to the at least one processor and storing processor-executable instructions which, when executed by the at least one processor, configure the at least one processor to provide a bidirectional application programming interface that interfaces between at least one provider system and at least one subscriber system, the bidirectional application programming interface configured to allow the at least one provider system to make requests of the at least one subscriber system and to allow the at least one subscriber system to make requests of the at least one provider system; receive, from a subscriber system, an application programming interface request that includes a request to confirm data processing particulars; identify, based on the data processing particulars, a provider system associated with the data processing particulars; send, to the provider system, the request to confirm the data processing particulars; receive, from the provider system, an indication that the data processing particulars are no longer valid and updated data processing particulars that are valid; and send, to the subscriber system, a response to the application programming interface request that includes the indication that the data processing particulars are no longer valid and the updated data processing particulars that are valid.

### TECHNICAL FIELD

The present application relates to systems and methods for responding to an application programming interface request.

### BACKGROUND

In virtual computer environments, hypervisors are used to manage the allocation and utilization of physical computer resources by virtual machines. Oftentimes, identifiers are used to uniquely reference a specific virtual processor within the virtual environment. Errors may occur in the event that an identifier of a virtual processor is changed or updated.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a simplified schematic diagram showing components of a bidirectional application programming interface according to an example embodiment;

FIG. 3 is a high-level schematic diagram of an example computer device;

FIG. 4 shows a simplified organization of software components stored in a memory of the example computer device of FIG. 3; and

FIG. 5 is a flowchart showing operations performed by a computer system in responding to an application programming interface request according to an example embodiment; and

FIG. 6 is a flowchart showing operations performed by a provider system in determining if data processing particulars are still valid according to an example embodiment.

Like reference numerals are used in the drawings to denote like elements and features.

### DETAILED DESCRIPTION OF VARIOUS EMBODIMENTS

Accordingly, in one aspect there is provided a computer system comprising at least one processor; a communications module coupled to the at least one processor; and a memory coupled to the at least one processor and storing processor-executable instructions which, when executed by the at least one processor, configure the at least one processor to provide a bidirectional application programming interface that interfaces between at least one provider system and at least one subscriber system, the bidirectional application programming interface configured to allow the at least one provider system to make requests of the at least one subscriber system and to allow the at least one subscriber system to make requests of the at least one provider system; receive, from a subscriber system, an application programming interface request that includes a request to confirm data processing particulars; identify, based on the data processing particulars, a provider system associated with the data processing particulars; send, to the provider system, the request to confirm the data processing particulars; receive, from the provider system, an indication that the data processing particulars are no longer valid and updated data processing particulars that are valid; and send, to the subscriber system, a response to the application programming interface request that includes the indication that the data processing particulars are no longer valid and the updated data processing particulars that are valid.

In one or more embodiments, the processor-executable instructions, when executed by the at least one processor, configure the at least one processor to receive, from the subscriber system, an application programming interface push request that includes data associated with the data processing particulars.

In one or more embodiments, the application programming interface push request is received from the subscriber system at predefined intervals.

In one or more embodiments, the processor-executable instructions, when executed by the at least one processor, configure the at least one processor to responsive to receiving the application programming interface push request, send, to the provider system, the data associated with the data processing particulars.

In one or more embodiments, the processor-executable instructions, when executed by the at least one processor, configure the at least one processor to receive, from the provider system, an application programming interface push request that includes updated data processing particulars that are valid.

In one or more embodiments, the processor-executable instructions, when executed by the at least one processor, configure the at least one processor to responsive to receiving the application programming interface push request that includes updated data processing particulars that are valid, send, to the subscriber system, the updated data processing particulars that are valid.

In one or more embodiments, the data processing particulars include at least an identifier of the provider system.

In one or more embodiments, the application programming interface request that includes the request to confirm data processing particulars is received prior to the subscriber system completing the data processing.

In one or more embodiments, the request to confirm the data processing particulars is sent by the subscriber system to reduce an error rate of the data processing by the subscriber system.

In one or more embodiments, prior to sending the indication that the data processing particulars are no longer valid and the updated data processing particulars that are valid, the provider system obtains consent to send the updated data processing particulars that are valid to the subscriber system.

In one or more embodiments, the processor-executable instructions, when executed by the at least one processor, configure the at least one processor to generate a list of all subscriber systems for a particular data record maintained by the provider system; and send, to the provider system, the list of all subscriber systems for the particular data record.

According to another aspect there is provided a computer-implemented method comprising providing a bidirectional application programming interface that interfaces between at least one provider system and at least one subscriber system, the bidirectional application programming interface configured to allow the at least one provider system to make requests of the at least one subscriber system and to allow the at least one subscriber system to make requests of the at least one provider system; receiving, from a subscriber system, an application programming interface request that includes a request to confirm data processing particulars; identifying, based on the data processing particulars, a provider system associated with the data processing particulars; sending, to the provider system, the request to confirm the data processing particulars; receiving, from the provider system, an indication that the data processing particulars are no longer valid and updated data processing particulars that are valid; and sending to the subscriber system, a response to the application programming interface request that includes the indication that the data processing particulars are no longer valid and the updated data processing particulars that are valid.

In one or more embodiments, the method further comprises receiving, from the subscriber system, an application programming interface push request that includes data associated with the data processing particulars.

In one or more embodiments, the application programming interface push request is received from the subscriber system at predefined intervals.

In one or more embodiments, responsive to receiving the application programming interface push request, the method comprises sending, to the provider system, the data associated with the data processing particulars.

In one or more embodiments, the method further comprises receiving, from the provider system, an application programming interface push request that includes updated data processing particulars that are valid.

In one or more embodiments, responsive to receiving the application programming interface push request that includes updated data processing particulars that are valid, the method comprises sending, to the subscriber system, the updated data processing particulars that are valid.

In one or more embodiments, the application programming interface request that includes the request to confirm data processing particulars is received prior to the subscriber system completing the data processing.

In one or more embodiments, the request to confirm the data processing particulars is sent by the subscriber system to reduce an error rate of the data processing by the subscriber system.

According to another aspect there is provided a non-transitory computer readable medium having stored thereon processor-executable instructions which, when executed by at least one processor, configure the at least one processor to provide a bidirectional application programming interface that interfaces between at least one provider system and at least one subscriber system, the bidirectional application programming interface configured to allow the at least one provider system to make requests of the at least one subscriber system and to allow the at least one subscriber system to make requests of the at least one provider system; receive, from a subscriber system, an application programming interface request that includes a request to confirm data processing particulars; identify, based on the data processing particulars, a provider system associated with the data processing particulars; send, to the provider system, the request to confirm the data processing particulars; receive, from the provider system, an indication that the data processing particulars are no longer valid and updated data processing particulars that are valid; and send, to the subscriber system, a response to the application programming interface request that includes the indication that the data processing particulars are no longer valid and the updated data processing particulars that are valid.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

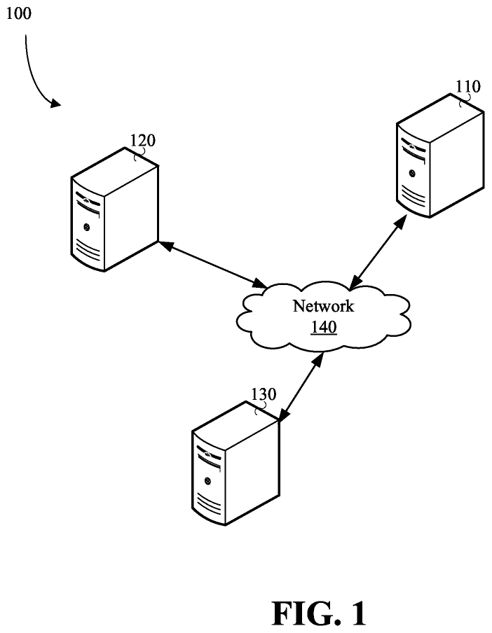

FIG. 1 is a schematic operation diagram illustrating an operating environment of an example embodiment. As shown, the system 100 includes a computer system 110, a provider system 120 and a subscriber system 130 coupled to one another through a network 140, which may include a public network such as the Internet and/or a private network. The computer system 110, the provider system 120 and the subscriber system 130 may be in geographically disparate locations. Put differently, the computer system 110, the provider system 120 and the subscriber system 130 may be located remote from one another. Although the computer system 110, the provider system 120, and the subscriber system 130 are illustrated as physical computer systems, it will be appreciated that the computer system 110, the provider system 120, and/or the subscriber system 130 may be cloud-based computer systems and/or virtual machines.

The computer system 110 may be, for example, a mainframe computer, a minicomputer, or the like. In some implementations thereof, a computer system may be formed of or may include one or more computing devices. A computer system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer system may include multiple computing devices organized in a tiered arrangement. For example, a computer system may include middle tier and back-end computing devices. In some embodiments, a computer system may be a cluster formed of a plurality of interoperating computing devices.

In one or more embodiments, the provider system 120 may be referred to as a hypervisor that may be configured to manage the allocation and utilization of physical computer resources by virtual machines. For example, the provider system 120 may maintain one or more virtual processors and may provide access to the one or more virtual processors. The one or more virtual processors may include virtual processor identifiers that may be generated by the provider system 120. The provider system 120 may change or update the virtual processor identifiers and this may be done, for example, upon expiration of a predefined period of time. For example, a virtual processor may be assigned a particular virtual processor identifier that may be valid for a period of time such as for example one (1) year. At the end of the year, the provider system 120 may perform operations to update or modify the particular virtual processor identifier. As will be described in more detail, this may be done to ensure that only authorized subscriber systems or virtual machines have access to the virtual processor.

In one or more embodiments, the provider system 120 may be configured to maintain and provide data processing particulars. For example, in one or more embodiments, the provider system 120 may maintain one or more payment cards such as for example credit cards. The one or more payment cards may include payment card identifiers such as for example a payment card number, primary account number, etc. and an expiration date. For example, a payment card may be assigned a particular payment card number that may be valid until the expiration date. Once expired, the provider system 120 may perform operations to update or modify the payment card number and expiration date and to issue a payment card based on the updated or modified payment card number and expiration date. As will be described in more detail, this may be done to ensure that only authorized subscriber systems have access to the payment card.

In one or more embodiments, the subscriber system 130 may be referred to as a virtual machine that may be provided access to one or more virtual processors managed by the provider system 120. The subscriber system 130 may access a specific virtual processor by using the particular virtual processor identifier thereof.

In one or more embodiments, the subscriber system 130 may be configured to generate data processing requests according to data processing particulars. For example, the subscriber system 130 may communicate data processing requests to the provider system 120. The data processing requests may include data processing particulars that may include an identifier such as for example a virtual processor identifier or a payment card identifier.

The network 140 is a computer network. In some embodiments, the network 140 may be an internetwork such as may be formed of one or more interconnected computer networks. For example, the network 140 may be or may include an Ethernet network, an asynchronous transfer mode (ATM) network, a wireless network, a telecommunications network, or the like.

Although in FIG. 1 the system 100 is described as including a provider system 120 and a subscriber system 130, it will be appreciated that in or more embodiments the system 100 may include a plurality of provider systems and a plurality of subscriber systems. Put another way, the system 100 may include at least one provider system and at least one subscriber system.

The computer system 110 may provide an application programming interface (API). The application programming interface may include a bidirectional application programming interface that may be configured to allow the at least one provider system to communicate requests of the at least one subscriber system and to allow the at least one subscriber system to communicate requests of the at least one provider system.

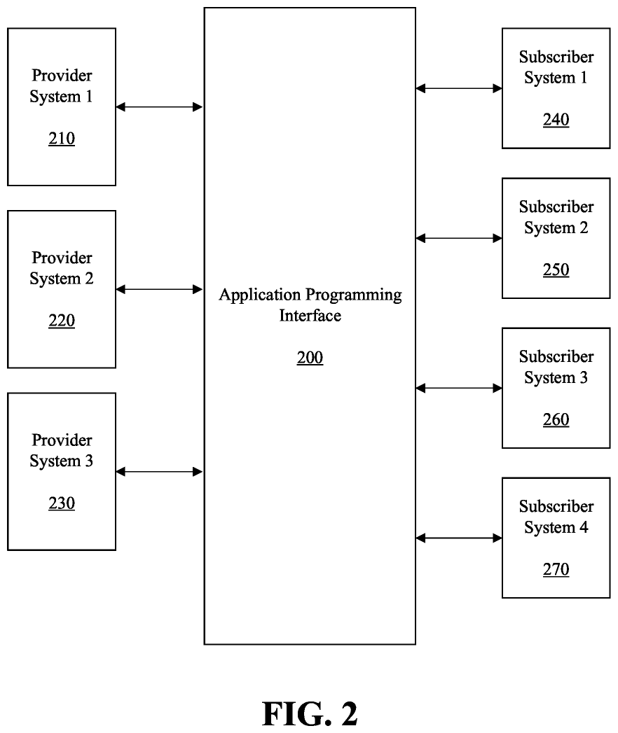

An example simplified schematic-diagram of a bidirectional application programming interface 200 is shown in FIG. 2. In one or more embodiments, the bidirectional application programming interface 200 may be referred to as a hypervisor application programming interface. The hypervisor application programming interface may be configured to interface between one or more hypervisors, which may include one or more provider systems, and one or more virtual processors, which may include one or more subscriber systems.

In the example shown in FIG. 2, the application programming interface 200 is in communication with a first provider system 210, a second provider system 220, and a third provider system 230 via a network which may include the network 140 (FIG. 1). The application programming interface 200 is also in communication with a first subscriber system 240, a second subscriber system 250, a third subscriber system 260, and a fourth subscriber system 270 via a network which may include the network 140 (FIG. 1). The application programming interface 200 is configured to allow the provider systems 210 to 230 to communicate requests of one or more of the subscriber systems 240 to 270 and to allow the subscriber systems 240 to 270 to communicate requests of one or more of the provider systems 210 to 230. In this manner, the application programming interface 200 acts as an interface between the provider systems 210 to 230 and the subscriber systems 240 to 270.

It will be appreciated that the application programming interface 200 shown in FIG. 2 is an example embodiment. In one or more embodiments, the application programming interface may be in communication with any number of provider systems and/or subscriber systems via one or more networks.

In one or more embodiments, the application programming interface 200 may include a representational state transfer (REST) application programming interface and/or a GraphQL application programming interface. For example, the application programming interface 200 may include the REST application programming interface and may utilize Hypertext Transfer Protocol (HTTP) methods (e.g. GET, POST) to receive and respond to application programming interface requests. Further operations of the application programming interface 200 will be described in more detail below.

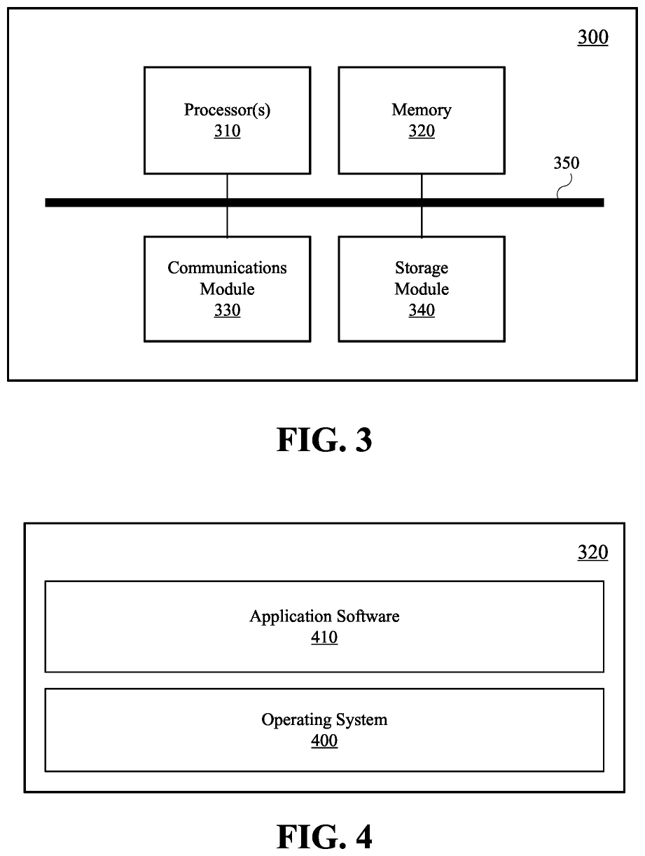

Referring now to FIG. 3, a high-level operation diagram of an example computing device 300 is shown. In some embodiments, the computing device 300 may be exemplary of the computer system 110, the provider system 120 and/or the subscriber system 130.

The example computing device 300 includes a variety of modules. For example, as illustrated, the example computing device 300 may include at least one processor 310, a memory 320, a communications module 330, and/or a storage module 340. As illustrated, the foregoing example modules of the example computing device 300 are in communication over a bus 350.

The at least one processor 310 is a hardware processor. The at least one processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are non-transitory computer-readable storage mediums. A computer-readable medium may be organized using a file system such as may be administered by an operating system governing overall operation of the example computing device 300.

The communications module 330 allows the example computing device 300 to communicate with other computer or computing devices and/or various communications networks. For example, the communications module 330 may allow the example computing device 300 to send or receive communications signals. Communications signals may be sent or received according to one or more protocols or according to one or more standards. For example, the communications module 330 may allow the example computing device 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computing device 300 to communicate using near-field communication (NFC), via Wi-Fi™, using Bluetooth™ or via some combination of one or more networks or protocols. In some embodiments, all or a portion of the communications module 330 may be integrated into a component of the example computing device 300. For example, the communications module may be integrated into a communications chipset. In some embodiments, the communications module 330 may be omitted such as, for example, if sending and receiving communications is not required in a particular application.

The storage module 340 allows the example computing device 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the at least one processor 310 in concert with the communications module 330 such as, for example, if data is stored remotely. The storage module may also be referred to as a data store.

Software comprising instructions is executed by the at least one processor 310 from a computer-readable medium. For example, software may be loaded into random-access memory from persistent storage of the memory 320. Additionally or alternatively, instructions may be executed by the at least one processor 310 directly from read-only memory of the memory 320.

FIG. 4 depicts a simplified organization of software components stored in the memory 320 of the example computing device 300 (FIG. 3). As illustrated, these software components include an operating system 400 and an application 410.

The operating system 400 is software. The operating system 400 allows the application 410 to access the at least one processor 310, the memory 320, and the communications module 330 of the example computing device 300 (FIG. 3). The operating system 400 may be, for example, Google™ Android™, Apple™ iOS™, UNIX™, Linux™, Microsoft™ Windows™, Apple OSX™ or the like.

The application 410 adapts the example computing device 300, in combination with the operating system 400, to operate as a device performing a particular function. For example, the application 410 may cooperate with the operating system 400 to adapt a suitable embodiment of the example computing device 300 to operate as the computer system 110, the provider system 120, and/or the subscriber system 130.

While a single application 410 is illustrated in FIG. 4, in operation the memory 320 may include more than one application 410 and different applications 410 may perform different operations.

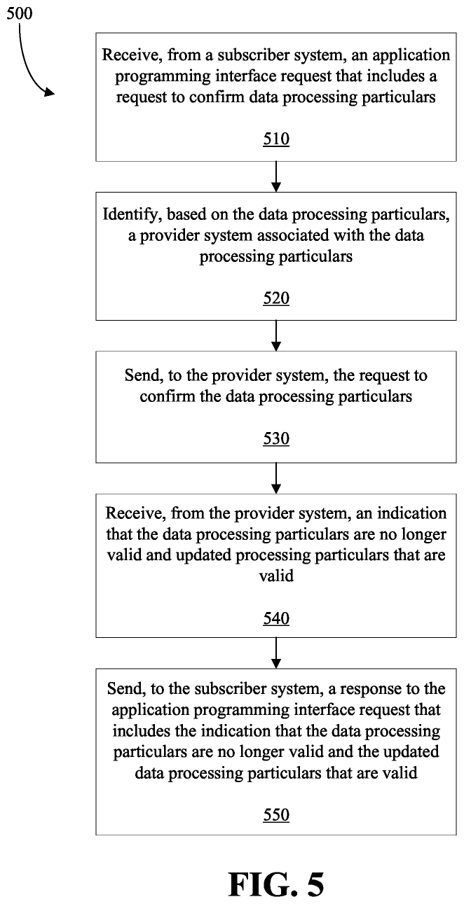

As mentioned, the computer system 110 may provide a bidirectional application programming interface that may be configured to allow at least one provider system to communicate requests of at least one subscriber system and to allow the at least one subscriber system to communicate requests of the at least one provider system. Reference is made to FIG. 5, which illustrates, in flowchart form, a method 500 for responding to an application programming interface request. The method 500 may be implemented by a computing device having suitable processor-executable instructions for causing the computing device to carry out the described operations. The method 500 may be implemented, in whole or in part, by the computer system 110.

The method 500 includes receiving, from a subscriber system, an application programming interface request that includes a request to confirm data processing particulars (step 510).

The application programming interface request may be received from a subscriber system such as for example the subscriber system 130.

In one or more embodiments, the request to confirm data processing particulars may include an identifier of a virtual processor. For example, the subscriber system may want to confirm that a particular virtual processor is valid, available or still exists prior to submitting a data processing request to the particular virtual processor. As such, the data processing particulars include the identifier of the particular virtual processor.

In one or more embodiments, the request to confirm data processing particulars may include an identifier such as for example a payment card number. For example, the subscriber system may want to confirm that a particular payment card number is valid, available or still exists prior to submitting a data processing request using the particular payment card number. As such, the data processing particulars include the payment card number.

In one or more embodiments, the data processing particulars may include at least an identifier of the provider system. For example, in embodiments where the bidirectional application programming interface is connected to more than one provider system, the data processing particulars may include an identifier of the provider system.

In embodiments where the data processing particulars include an identifier of a virtual processor, the identifier of the virtual processor may include an identifier of the provider system. For example, an identifier of a virtual processor may include “vCPU1.1” and as such the provider system may be identified using the first number after “vCPU” which in this case is provider system “1”. In this example, the virtual processor itself may be identified using the first number after the period “.” which in this case is virtual processor “1”. For clarity, in another example an identifier of a virtual processor may include “vCPU2.23” and as such the provider system may be provider system “2” and the virtual processor may be virtual processor “23”

In embodiments where the data processing particulars include a payment card number, the payment card number may include an identifier of the provider system. For example, the first four (4) digits of the payment card number may identify an issuer of the payment card and as such the provider system may be identified.

The method 500 includes identifying, based on the data processing particulars, a provider system associated with the data processing particulars (step 520).

In one or more embodiments, the data processing particulars may be analyzed to identify a provider system associated with the data processing particulars.

In one or more embodiments, the computer system 110 may maintain a lookup table that may be consulted to identify the provider system. For example, the lookup table may include a list of virtual processor identifiers and may associate each virtual processor identifier with a particular hypervisor or provider system. In this example, the computer system 110 may consult the lookup table and may identify the particular hypervisor or provider system using the virtual processor identifier.

In one or more embodiments, the data processing particulars may include at least an identifier of the provider system. As such, the computer system 110 may identify the provider system based on the identifier of the provider system. For example, the data processing particulars may include an identifier of a virtual processor such as “vCPU1.1” and as such the provider system may be identified using the first number after “vCPU” which in this case is provider system “1”. As another example, the data processing particulars may include a payment card number that may include an identifier of the provider system. For example, the first four (4) digits of the payment card number may identify an issuer of the payment card and as such the provider system may be identified.

In one or more embodiments, once the provider system has been identified, the computer system 110 may perform operations to obtain an electronic address of the provider system. For example, the computer system 110 may maintain a lookup table that may be consulted to obtain an electronic address of a provider system. For example, the lookup table may include a list of provider systems and may associate each provider system with an electronic address. In this example, the computer system 110 may consult the lookup table and may identify the electronic address using the identifier of the provider system.

The method 500 includes sending, to the provider system, the request to confirm the data processing particulars (step 530).

Once the provider system has been identified, the computer system 110 sends the request to confirm the data processing particulars. The request to confirm that data processing particulars may be in a standard format or may be in a format required by or compliant with the provider system.

In one or more embodiments, the computer system 110 may translate the request to confirm the data processing particulars into a format compliant with the identified provider system. For example, once the provider system has been identified, the computer system 110 may perform operations to determine the format compliant with the provider system. For example, the computer system 110 may maintain a lookup table that may be consulted to determine the format compliant with the provider system. For example, the lookup table may include a list of provider systems and may associate each provider system with a particular electronic format for receiving a request. The particular electronic format may include a direct data format such as for example JavaScript Object Notation (JSON), Extensible Markup Language (XML), etc.

In one or more embodiments, the request to confirm the data processing particulars includes an identifier such as for example an identifier of a particular virtual processor or a payment card number.

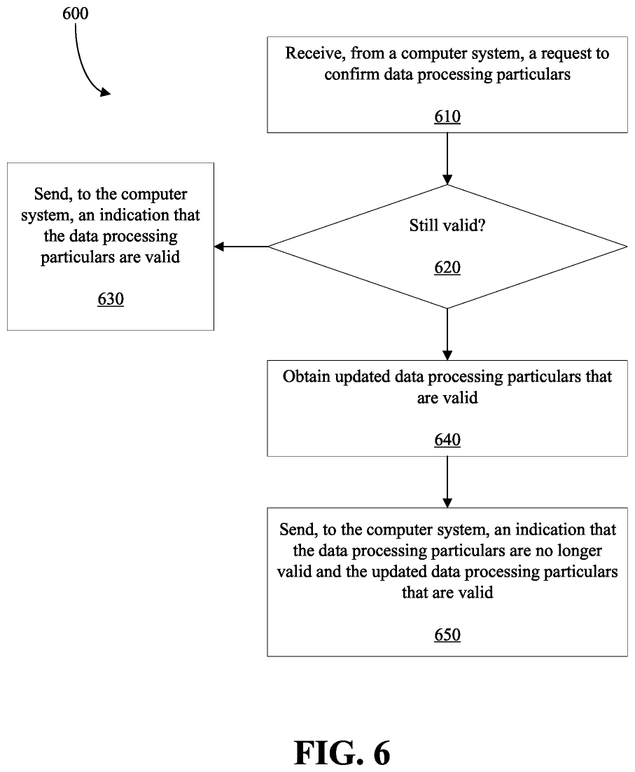

In response to receiving the request to confirm the data processing particulars, the provider system may perform operations to determine whether or not the data processing particulars are valid. Reference is made to FIG. 6, which illustrates, in flowchart form, a method 600 for determining whether or not data processing particulars are valid. The method 600 may be implemented by a computing device having suitable processor-executable instructions for causing the computing device to carry out the described operations. The method 600 may be implemented, in whole or in part, by the provider system 120.

The method 600 includes receiving, from a computer system, a request to confirm data processing particulars (step 610).

The provider system receives the request to confirm the data processing particulars. As mentioned, the data processing particulars may include an identifier such as for example an identifier of a particular virtual processor or a payment card number.

The method 600 includes determining whether or not the data processing particulars are valid (step 620).

The provider system 120 determines whether or not the data processing particulars are valid. For example, in one or more embodiments, the provider system 120 may analyze the identifier to determine whether or not the identifier is still valid.

To determine whether or not the identifier is still valid, the provider system 120 may consult a database or lookup table. The database or lookup table may include a list of all identifiers generated by the provider system and an associated status thereof. The status may be, for example, “active”, “valid”, “not active” or “not valid”, for example.

In response to determining that the data processing particulars are valid, the method 600 includes sending, to the computer system, an indication that the data processing particulars are valid (step 630).

The provider system 120 may determine that the data processing particulars are valid and in response, may communicate an indication that the data processing particulars are valid to the computer system. In one or more embodiments, the indication may include a binary response such as a “1” that may indicate that the data processing particulars are valid.

In response to determining that the data processing particulars are not valid, the method 600 includes obtaining updated data processing particulars that are valid (step 640).

In response to determining that the data processing particulars are not valid, the provider system 120 may determine or identify data processing particulars that are valid.

For example, it may be determined that a particular virtual processor identified by the identifier is no longer available or no longer exists and as such it may be determined that the data processing particulars are not valid. The provider system 120 may then determine or identify data processing particulars that are valid. For example, the provider system 120 may determine an updated virtual processor identifier for the particular virtual processor or may identify or determine a different virtual processor that may be used.

As another example, it may be determined that the payment card number is no longer valid. For example, the payment card number may have expired or may have been cancelled or replaced. The provider system 120 may then determine or identify a replacement payment card number. For example, the payment card may have been replaced and as such a payment card number of the replacement payment card may be obtained.

In one or more embodiments, the provider system 120 may obtain consent to send the updated data processing particulars. For example, the provider system may send a notification to a client device that identifies the subscriber system and includes a request to release an updated payment card number to the subscriber system. A user may respond to the notification and this may include an indication of consent to release the updated payment card number to the subscriber system.

In one or more embodiments, the lookup table maintained by the provider system 120 may additionally or alternatively include an updated identifier. For example, for any identifiers that are flagged as “not valid”, the lookup table may include or may map to an updated identifier that is “valid”. In this example, the updated identifier may serve as a replacement identifier for the “not valid” data processing particulars. In this manner, the provider system 120 may obtain data processing particulars that are valid.

The method 600 includes sending, to the computer system, an indication that the data processing particulars are no longer valid and the updated data processing particulars that are valid (step 650).

In embodiments where the provider system 120 determines that the data processing particulars are not valid, the provider system may communicate an indication that the data processing particulars are not valid to the computer system. In one or more embodiments, the indication may include a binary response such as a “0” that may indicate that the data processing particulars are not valid. In addition to the indication, the provider system 120 may communicate the updated data processing particulars that are valid.

Referring back to FIG. 5, the method 500 includes receiving, from the provider system, an indication that the data processing particulars are no longer valid and updated data processing particulars that are valid (step 540).

The computer system 110 receives the indication that the data processing particulars are no longer valid. As mentioned, the indication may include a binary response such as a “0” that may indicate that the data processing particulars are no longer valid.

The computer system 110 also receives the updated data processing particulars that are valid. As mentioned, the updated data processing particulars may include an identifier of a particular virtual processor or a payment card number that may be used for completing a data processing request according to the data processing particulars.

The method 500 includes sending, to the subscriber system, a response to the application programming interface request that includes the indication that the data processing particulars are no longer valid and the updated data processing particulars that are valid (step 550).

In one or more embodiments, prior to sending the response to the application programming interface request, the computer system 110 may translate the indication that the data processing particulars are no longer valid and the updated data processing particulars that are valid into a format compliant with the subscriber system and this may be based on a format of the application programming interface request received during the step 510.

In response to receiving the indication that the data processing particulars are no longer valid and the updated data processing particulars that are valid, the subscriber system may perform operations to complete data processing according to the updated data processing particulars. By sending the request to confirm the data processing particulars before attempting to complete the data processing, an error rate of the data processing is reduced. Put another way, should the subscriber system attempt data processing according to the data processing particulars without sending a request to confirm the data processing particulars, the attempt may result in an error and this may unnecessarily occupy a network used for the data processing. Further, continued attempts at data processing using data processing particulars that are no longer valid results in an increased usage of computer resources that could otherwise be avoided should the subscriber system utilize the methods described herein.

In embodiments described herein, the provider system 120 may periodically or frequently change or update identifiers. For example, the identifier of a particular virtual processor may be changed or updated every month or year. As such, through use of the application programming interface provided by the computer system 110, unauthorized or otherwise stale subscriber systems may not have access to the particular virtual processor. Put another way, changing or updating the identifier may indicate expiration of granted access to the particular virtual processor. The subscriber system may then be required to obtain the updated identifier of the particular virtual processor and this may allow the providing system to review and update what subscriber systems have access to what virtual processors.

In one or more embodiments, the data processing completed by the subscriber system may utilize a different network than the network utilized to send the request to confirm the data processing particulars. For example, in embodiments where the data processing particulars include a payment card number, the subscriber system may utilize a first network to obtain an updated payment card number that is valid and may utilize a second, different network to complete a transaction using the updated payment card number.

In one or more embodiments, the computer system 110 and/or the provider system 120 may maintain a list of subscriber systems that have access to one or more identifiers associated therewith. For example, the computer system 110 and/or the provider system 120 may maintain a list of all virtual machines that have access to or utilize a particular virtual processor. In this example, a list of all subscriber systems for a particular virtual processor associated with the provider system 120 may be generated. In embodiments where the list is maintained by the computer system 110, the computer system 110 may provide the list to the provider system 120.

As another example, the provider system 120 may maintain a lookup table or list of all subscriber systems that periodically process transactions on a particular payment card number. In this example, the subscriber systems may be associated with merchants or service providers that may offer subscription based services and as such periodically conduct transactions on payment cards. In this example, a list of all subscriber systems for a particular payment card number may be generated. In embodiments where the list is maintained by the computer system 110, the computer system 110 may provide the list to the provider system 120.

In one or more embodiments, the provider system may communicate application programming interface requests to the computer system 110 that may request data from one or more of the subscriber systems. For example, the provider system may communicate an application programming interface request that includes a request for a schedule to access a particular virtual processor. In response, the computer system 110 may perform operations to obtain the schedule from one or more of the subscriber systems and may communicate the obtained schedule as a response to the application programming interface request. The provider system may utilize the schedule to ensure access to the virtual processor is available at the requested time(s).

In one or more embodiments, the subscriber system may communicate push requests to the computer system 110 that may include data associated with the data processing particulars. For example, the subscriber system may perform operations to complete a data processing request and may send an indication of completion of the data processing to the computer system 110. In this example, the data processing request may include transaction processing and the indication of completion of the transaction processing may include a receipt, statement or invoice for the completed transaction. In one or more embodiments, the push request may be received from the subscriber system at predefined intervals. For example, the subscriber system may be associated with a merchant or service provider that may offer a subscription based service and periodically conduct transactions on payment cards. As such, the subscriber system may complete a transaction on a payment card and may send a receipt, statement of invoice for the completed transaction. In response to receiving the application programming interface push request, the computer system 110 may send, to the provider system, the data associated with the data processing particulars. For example, the computer system 110 may identify a provider system based on a payment card identifier and may communicate the data associated with the data processing particulars to the provider system.

In one or more embodiments, the provider system may communicate push requests to the computer system 110 and this may be done to automatically communicate updated data processing particulars that are valid to one or more subscriber systems. For example, each time an identifier is updated or changed, the provider system may communicate an application programming interface push request to the computer system 110 that includes updated data processing particulars that are valid. In response, the computer system 110 may identify one or more subscriber systems that periodically process transactions on a particular payment card or periodically access a particular virtual processor and this may be done, for example, by consulting a lookup table. The computer system 110 may then communicate the updated data processing particulars that are valid to the identified subscriber systems.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A computer system comprising:
at least one processor;
a communications module coupled to the at least one processor; and
a memory coupled to the at least one processor and storing processor-executable instructions which, when executed by the at least one processor, configure the at least one processor to:
provide a bidirectional application programming interface that interfaces between at least one provider system and at least one subscriber system, the bidirectional application programming interface configured to allow the at least one provider system to make requests of the at least one subscriber system and to allow the at least one subscriber system to make requests of the at least one provider system;
receive, from a subscriber system, an application programming interface request that includes a request to confirm data processing particulars;
identify, based on the data processing particulars, a provider system associated with the data processing particulars;
send, to the provider system, the request to confirm the data processing particulars;
receive, from the provider system, an indication that the data processing particulars are no longer valid and updated data processing particulars that are valid; and
send, to the subscriber system, a response to the application programming interface request that includes the indication that the data processing particulars are no longer valid and the updated data processing particulars that are valid.

2. The computer system of claim 1, wherein the processor-executable instructions, when executed by the at least one processor, configure the at least one processor to:
receive, from the subscriber system, an application programming interface push request that includes data associated with the data processing particulars.

3. The computer system of claim 2, wherein the application programming interface push request is received from the subscriber system at predefined intervals.

4. The computer system of claim 2, wherein the processor-executable instructions, when executed by the at least one processor, configure the at least one processor to:
responsive to receiving the application programming interface push request, send, to the provider system, the data associated with the data processing particulars.

5. The computer system of claim 1, wherein the processor-executable instructions, when executed by the at least one processor, configure the at least one processor to:
receive, from the provider system, an application programming interface push request that includes updated data processing particulars that are valid.

6. The computer system of claim 5, wherein the processor-executable instructions, when executed by the at least one processor, configure the at least one processor to:
responsive to receiving the application programming interface push request that includes updated data processing particulars that are valid, send, to the subscriber system, the updated data processing particulars that are valid.

7. The computer system of claim 1, wherein the data processing particulars include at least an identifier of the provider system.

8. The computer system of claim 1, wherein the application programming interface request that includes the request to confirm data processing particulars is received prior to the subscriber system completing the data processing.

9. The computer system of claim 8, wherein the request to confirm the data processing particulars is sent by the subscriber system to reduce an error rate of the data processing by the subscriber system.

10. The computer system of claim 1, wherein prior to sending the indication that the data processing particulars are no longer valid and the updated data processing particulars that are valid, the provider system obtains consent to send the updated data processing particulars that are valid to the subscriber system.

11. The computer system of claim 1, wherein the processor-executable instructions, when executed by the at least one processor, configure the at least one processor to:
generate a list of all subscriber systems for a particular data record maintained by the provider system; and
send, to the provider system, the list of all subscriber systems for the particular data record.

12. A computer-implemented method comprising:
providing a bidirectional application programming interface that interfaces between at least one provider system and at least one subscriber system, the bidirectional application programming interface configured to allow the at least one provider system to make requests of the at least one subscriber system and to allow the at least one subscriber system to make requests of the at least one provider system;
receiving, from a subscriber system, an application programming interface request that includes a request to confirm data processing particulars;
identifying, based on the data processing particulars, a provider system associated with the data processing particulars;
sending, to the provider system, the request to confirm the data processing particulars;
receiving, from the provider system, an indication that the data processing particulars are no longer valid and updated data processing particulars that are valid; and
sending to the subscriber system, a response to the application programming interface request that includes the indication that the data processing particulars are no longer valid and the updated data processing particulars that are valid.

13. The computer-implemented method of claim 12, further comprising:
receiving, from the subscriber system, an application programming interface push request that includes data associated with the data processing particulars.

14. The computer-implemented method of claim 13, wherein the application programming interface push request is received from the subscriber system at predefined intervals.

15. The computer-implemented method of claim 13, wherein responsive to receiving the application programming interface push request, the method comprises:
sending, to the provider system, the data associated with the data processing particulars.

16. The computer-implemented method of claim 12, further comprising:
receiving, from the provider system, an application programming interface push request that includes updated data processing particulars that are valid.

17. The computer-implemented method of claim 16, wherein responsive to receiving the application programming interface push request that includes updated data processing particulars that are valid, the method comprises:
sending, to the subscriber system, the updated data processing particulars that are valid.

18. The computer-implemented method of claim 12, wherein the application programming interface request that includes the request to confirm data processing particulars is received prior to the subscriber system completing the data processing.

19. The computer-implemented method of claim 18, wherein the request to confirm the data processing particulars is sent by the subscriber system to reduce an error rate of the data processing by the subscriber system.

20. A non-transitory computer readable medium having stored thereon processor-executable instructions which, when executed by at least one processor, configure the at least one processor to:
provide a bidirectional application programming interface that interfaces between at least one provider system and at least one subscriber system, the bidirectional application programming interface configured to allow the at least one provider system to make requests of the at least one subscriber system and to allow the at least one subscriber system to make requests of the at least one provider system;
receive, from a subscriber system, an application programming interface request that includes a request to confirm data processing particulars;
identify, based on the data processing particulars, a provider system associated with the data processing particulars;
send, to the provider system, the request to confirm the data processing particulars;
receive, from the provider system, an indication that the data processing particulars are no longer valid and updated data processing particulars that are valid; and
send, to the subscriber system, a response to the application programming interface request that includes the indication that the data processing particulars are no longer valid and the updated data processing particulars that are valid.
